(19) United States
(12) Patent Application Publication
(10) Pub. No.: US 2003/0206787 A1
(43) Pub. Date: Nov. 6, 2003

(54) Anchoring screw with double heads and triple threads of different depths of thread

(75) Inventor: Pan-Ching Huang, Changhua (TW)

Correspondence Address: BRUCE H. TROXELL, SUITE 1404, 5205 LEESBURG PIKE,, FALLS CHURCH, VA, 22041, US

(73) Assignee: Joker Industrial Co., Ltd.

(21) Appl. No.: 10/135,355

(22) Filed: May 1, 2002

(51) Int. Cl. F16B 35/04

(52) U.S. Cl. 411/412

(57) ABSTRACT

An anchoring screw with double heads and triple threads of different depths of thread mainly includes a polygonal flange (or a polygonal sunken cavity) formed on the screw for fastening use. The screw has an upper section and a lower section forming respectively two bolts which have different screw thread specifications. One of the bolts has at least triple threads equally spaced from one another. The triple threads have different depths of thread. Thus the bolt of triple threads can provide an effective balance function when fastened into a construction hole to maintain a firm fastening without skewing. The screw threads of different depths of thread can also gather extruded cement debris when the screw is fastened into the construction hole to produce a stronger fastening effect. As there is no expansion incurred, the wall or board does not crack. Therefore the interval between the construction holes may be shortened, and number of construction holes may be effectively increased in a given unit area. The anchoring screw of the invention also may be removed easily and conveniently to facilitate construction.

### BACKGROUND OF THE INVENTION

1. Field of the Invention

The invention relates to an anchoring screw that has double heads and triple threads of different depths of thread and particularly to a double heads anchoring screw for fastening to cement walls (or other construction panels and boards).

2. Description of the Prior Art

Referring to FIG. 1, a conventional method for mounting or hanging articles on a cement wall 1 (or other construction boards and panels) usually is done by fastening an expanded screw 2 into a construction hole 11, then installing a bolt 21 therein for mounting or hanging an article or object desired. Such a construction method has many problems, notably:

1. Anchoring of the expanded screw 2 requires to use a special pliers or tool to pull the conical front end 211 of the bolt 21 to expand the nail fastener 22 to firmly engage with the construction hole 11. The cement wall is prone to crack during the expansion process. It is a big disadvantage of using such type of expanded screw.

2. Installing the expanded screw 2 requires a special pliers or tool, and makes construction work inconvenient.

3. Once the expanded screw 2 is installed and anchored in the construction hole 11, it is very difficult to remove.

4. As the expanded screw 2 tends to cause the cement wall crack around the construction hole, the interval between the construction holes must be increase to a longer distance, especially on the corners of the walls. As a result, the number of construction holes for an unit of wall surface is limited, and the connecting strength between the wall and boards is affected, and the number of articles or objects that can be supported or hung is restricted.

### SUMMARY OF THE INVENTION

In view of aforesaid disadvantages, the primary object of the invention is to provide an improved anchoring screw that has a polygonal flange (or a polygonal cavity) for fastening use and a bolt which has an upper section and a lower section forming respectively thereon screw threads of different specifications. One of the bolt sections has at least three different screw threads formed thereon in an equally spaced manner thereby may fasten to the wall or board firmly without skewing, and the different screw threads have different depths of thread for gathering cement debris generated during installation and extruding processes thereby creates a greater fastening effect. As there is no expansion incurred, the wall or board does not crack, and the interval between the construction holes may be shortened. As a result, non-usable anchoring areas near the corners of the wall can be reduced, and number of construction holes may be increased on a given unit area. The anchoring screw of the invention also may be removed easily and conveniently to facilitate construction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional expanded screw in an operating condition.

FIG. 2 is a perspective view of the invention.

FIG. 3 is a sectional view of the invention.

FIG. 4 is a cross section according to FIG. 3.

FIG. 5 is a schematic view of the invention in an operating condition.

FIG. 6 is a perspective view of another embodiment of the invention.

FIG. 7 is a schematic view of another embodiment of the invention in an operating condition.

FIG. 8 is a perspective view of yet another embodiment of the invention.

FIG. 9 is a schematic view of yet another embodiment of the invention in an operating condition.

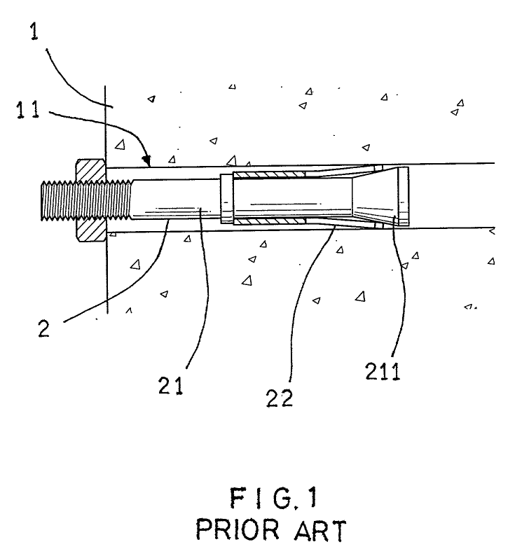

### DESCRIPTION OF THE PREFERRED EMBODIMENTS

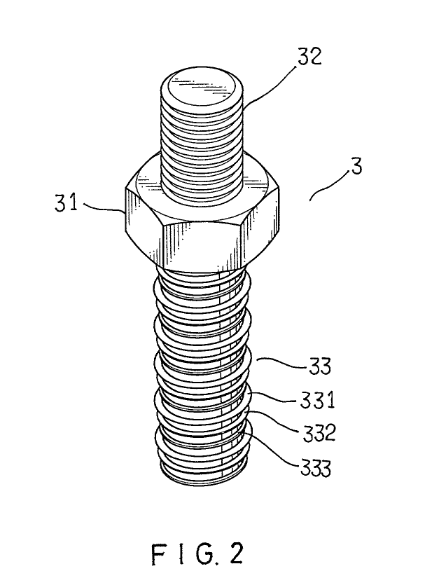

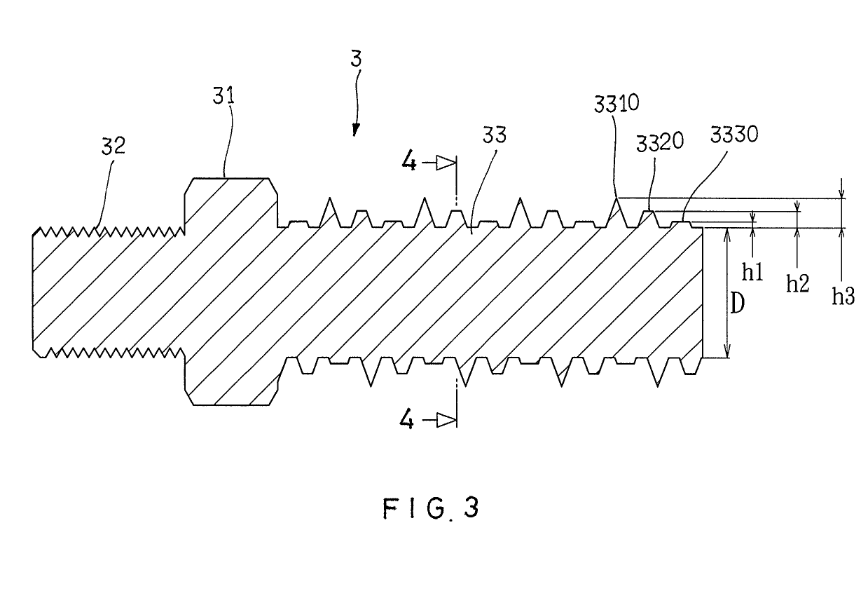

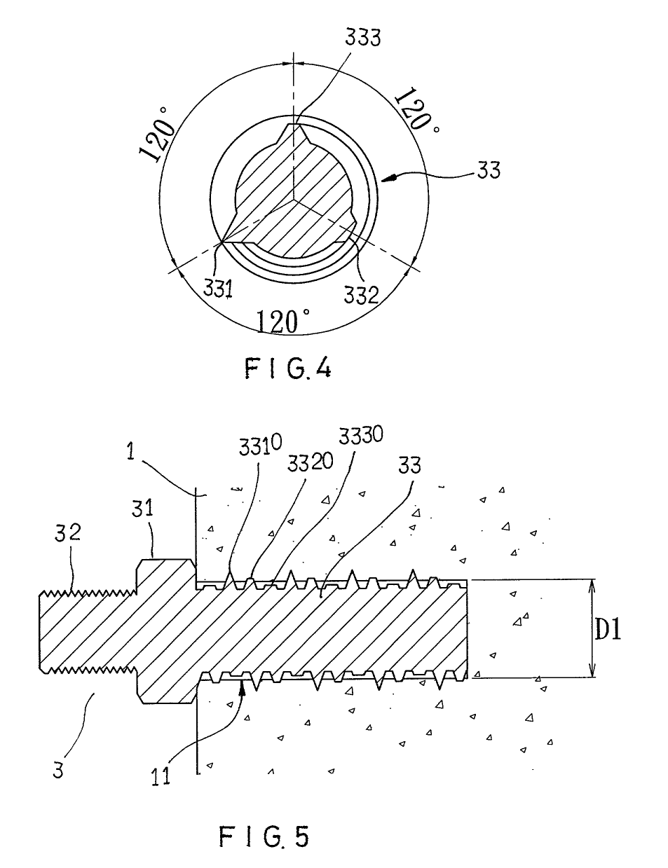

Referring to FIGS. 2 and 3, the screw 3 of the invention mainly includes a polygonal flange 31 for fastening use (the flange may be clamped by a general wrench for turning and fastening operations). The shank of the screw 3 includes an upper section and a lower section to form respectively an upper bolt 32 and a lower bolt 33 which have respectively screw threads of different specifications. The polygonal flange 31 may be located between the upper bolt 32 and the lower bolt 33. The lower bolt 33 has three different screw threads 331, 332, and 333 formed thereon (the number of screw threads may be three, five or the like) so that each lead is three times of the pitch (this is for the embodiment of triple threads). Moreover, the screw edges 3310, 3320 and 3330 of the screw threads 331, 332 and 333 have respectively different heights (also called depth of thread) h1, h2 and h3. Hence when the lower bolt 33 is fastened into a construction hole 11 of a cement wall (as shown in FIG. 5), the three screw threads 331, 332 and 333 are spaced from one another in an equally spaced manner (this is based on the embodiment of triple threads as an example, please also refer to FIG. 4), and the screw threads 331, 332 and 333 are located in an angular interval of 120 degrees with one another. On the cross section, there are three equally spaced screw thread tangent lines, therefore can provide a balance effect to maintain the bolt firmly positioned without skewing. In addition, as the heights h1, h2 and h3 of the screw edges 3310, 3320 and 3330 of the screw threads 331, 332 and 333 are different, when the screw edges 3310, 3320 and 3330 are fastened into the construction hole 11 (a general construction hole 11 has a diameter D1 which is between the small diameter D of the lower bolt 33 and the outer diameter of the smallest height h1, i.e. D<D1+2h1), the screw edges can gather extruded cement debris to generate a stronger fastening effect. Furthermore, as there is no expansion, the wall or board does not crack. Hence the interval between the construction holes may be shortened. As a result, non-usable anchoring areas near the corners of the wall can be reduced, and number of construction holes may be increased on a given unit area. The anchoring screw of the invention also may be removed easily and conveniently to facilitate construction.

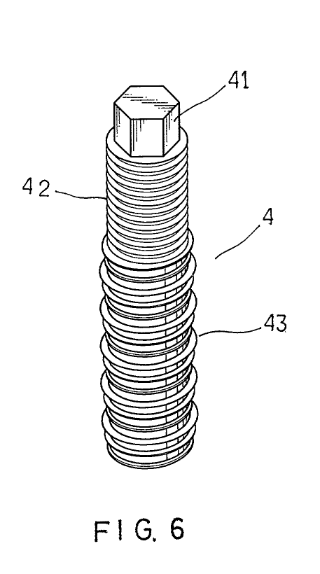

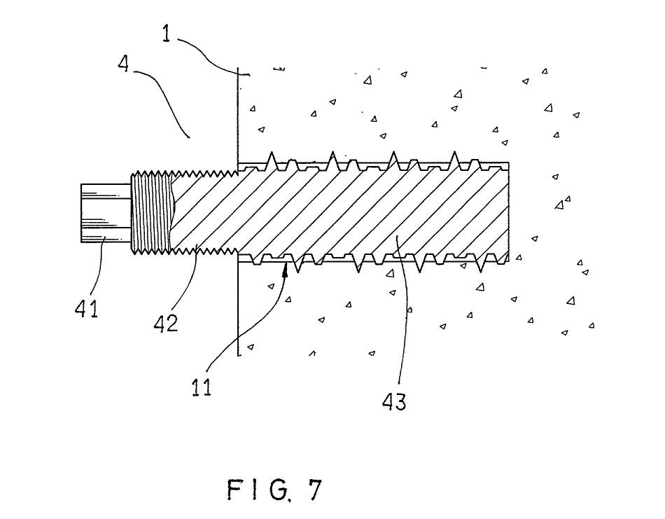

Refer to FIGS. 6 and 7 for another embodiment of the invention. The screw 4 includes an upper section and a lower section forming respectively an upper bolt 42 and a lower bolt 43 of different screw thread specifications. The lower bolt 43 has triple threads with different screw edge heights (same as the embodiment shown in FIG. 2). However, the polygonal flange 41 for fastening use is located on the top end of the upper bolt 42 (i.e. the bolt exposed outside the construction hole, and the polygonal flange 41 has an outer diameter smaller than the diameter of the upper bolt 42 to enable external objects mounting on the upper bolt 42 without impediment).

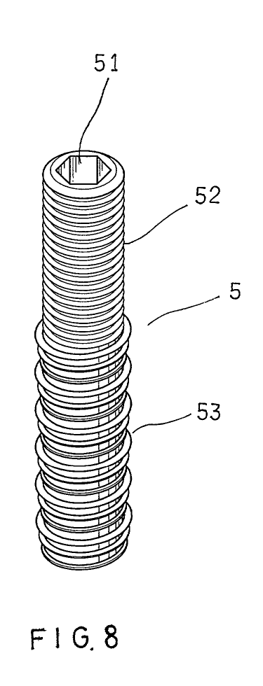

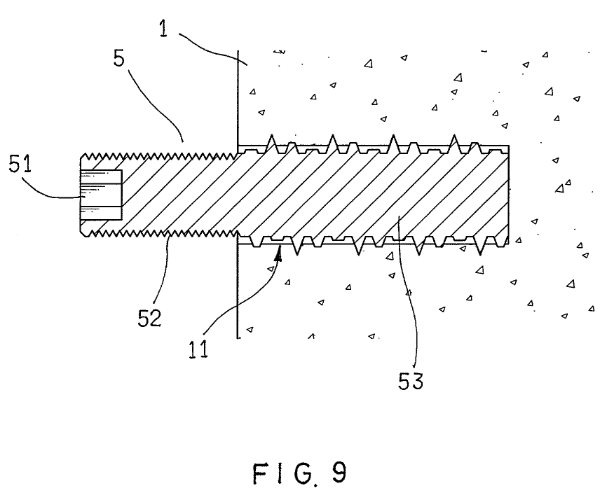

Refer to FIGS. 8 and 9 for yet another embodiment of the invention. The screw 5 includes an upper section and a lower section forming respectively an upper bolt 52 and a lower bolt 53 of different screw thread specifications. The lower bolt 53 has triple threads with different screw edge heights (same as the embodiment shown in FIG. 2). However, the polygonal flange for fastening use is changed to become a polygonal sunken cavity 51 formed in the top end of the upper bolt 52 engageable with a matching wrench for fastening use.

By means of the construction set forth above, the screw of the invention may be operated and fastened by a general wrench without using special tools, and the screw may be fastened and anchored firmly without skewing. The screw of the invention can also gather cement debris to produce a greater fastening effect. As there is no expansion when the invention is installed, cracks on the walls or boards that might otherwise incur may be avoided from happening. The screw of the invention also is easy to remove when desired. All this provides significant improvements and greater benefits.

I claim:

1. An anchoring screw with double heads and triple threads of different depths of thread, comprising:
a polygonal flange for fastening use; and
an upper section and a lower section for forming respectively an upper bolt and a lower bolt which have respectively screw threads of different specifications formed thereon;
wherein one of the bolts has at least triple threads formed thereon in an equally spaced fashion, the triple threads having different depths of thread.

2. The anchoring screw of claim 1, wherein the polygonal flange is located in a middle section of the screw between the upper bolt and the lower bolt.

3. The anchoring screw of claim 1, wherein the polygonal flange is located on a top end of one bolt exposed outside a construction hole.

4. The anchoring screw of claim 1, wherein the exposed top end of one bolt outside a construction hole has a polygonal sunken cavity formed therein to engage with a matching wrench for fastening operation to substitute the polygonal flange.
